(19) United States
(12) Patent Application Publication
(10) Pub. No.: US 2024/0417233 A1
(43) Pub. Date: Dec. 19, 2024

(54) GAS CANISTERS, CAPS FOR GAS CANISTERS, AND METHODS FOR MAKING THEM

(71) Applicant: ALTAVIZ, LLC, Irvine, CA (US)

(72) Inventors: Peter L. Bliss, Prior Lake, MN (US); Jack R. Auld, Laguna Niguel, CA (US); Matthew McCawley, Grant, FL (US); Eric Anderfaas, Westminster, CA (US)

(21) Appl. No.: 18/748,031

(22) Filed: Jun. 19, 2024

Related U.S. Application Data
(60) Provisional application No. 63/521,839, filed on Jun. 19, 2023.

(51) Int. Cl. B67C 3/10; B67B 3/02

(52) U.S. Cl. CPC B67C 3/10; B67B 3/023

(57) ABSTRACT

Gas canisters are provided that include an elongate body comprising a barrel region defining a first diameter, an enclosed first end, and a neck region extending from the barrel region to an open second end defining an end wall, the elongate body defining a central axis extending between the first end and the second end; a cap attached to the neck region to close the second end of the elongate body and enclose the cavity, the cap comprising an end wall including an opening therethrough communicating with the cavity, and a seat surrounding the opening on an interior of the end wall; and a sealing member within the neck region configured to engage the seat to seal the opening, the cavity filled with pressurized fluid.

### RELATED APPLICATION DATA

The present application claims benefit of co-pending U.S. provisional application Ser. No. 63/521,839, filed Jun. 19, 2023, the entire disclosure of which is expressly incorporated by reference herein.

### TECHNICAL FIELD

The present application relates generally to canisters for storing gases, and, more particularly, to single-use gas canisters that may be loaded into or otherwise provided in a medical device or other tool to provide energy during use of the medical device or other tool, and to methods for making such canisters.

### BACKGROUND

Various surgical procedures involve the use of medical devices that require an energy source, e.g., to provide a discharge force to components of the devices. For example, an intraocular lens (“IOL”) inserter device may be used to deliver a replacement lens within an eye suffering from a cataract. Such an IOL inserter may require an external power source to push a lens loaded into the inserter into a patient's eye. Similarly, intraocular injector devices may be gas-powered and require a reliable and/or convenient gas source for providing pressurized gas for operating the devices.

Accordingly, energy sources for gas-powered IOL inserters and other medical devices or tools would be useful.

### SUMMARY

The present application is directed to canisters for storing gases, and, more particularly, to single-use gas canisters that may be loaded into or otherwise provided in a medical device or other tool to provide energy during use of the medical device or other tool, and to methods for making such canisters.

In accordance with one example, a gas canister is provided that includes an elongate body comprising a barrel region defining a first diameter, an enclosed first end, and a neck region extending from the barrel region to an open second end defining an end wall, the elongate body defining a central axis extending between the first end and the second end; a cap attached to the neck region to close the second end of the elongate body and enclose a cavity within the body, the cap comprising an end wall including an opening therethrough communicating with the cavity, and a seat surrounding the opening on an interior of the end wall; and a sealing member within the neck region configured to engage the seat to seal the opening, the cavity filled with pressurized fluid.

In accordance with another example, a gas canister is provided that includes an elongate body comprising a barrel region defining a first diameter, an enclosed first end, and a neck region extending from the barrel region to an open second end defining an end wall, the elongate body defining a central axis extending between the first end and the second end; a cap attached to the neck region to close the second end of the elongate body and enclose a cavity within the body, the cap comprising an end wall including an opening therethrough communicating with the cavity, and a seat surrounding the opening on an interior surface of the cap comprising a concave wall; and a sealing member within the neck region comprising a spherical member configured to engage the concave wall of the seat to seal the opening, the cavity filled with pressurized fluid.

In accordance with still another example, a gas canister is provided that includes an elongate body comprising a barrel region defining a first diameter, an enclosed first end, and a neck region extending from the barrel region to an open second end defining an end wall, the elongate body defining a central axis extending between the first end and the second end; a cap attached to the neck region to close the second end of the elongate body and enclose a cavity within the body, the cap comprising an end wall including an opening therethrough communicating with the cavity, and a shoulder surrounding the opening on an interior surface of the cap; and a sealing member within the neck region comprising a flat disk spherical member comprising a flat surface configured to engage the shoulder to seal the opening and a stem extending from the flat surface through the opening, the cavity filled with pressurized fluid.

In accordance with yet another example, a gas canister is provided that includes an elongate body comprising a barrel region defining a first diameter, an enclosed first end, and a neck region extending from the barrel region to an open second end defining an end wall, the elongate body defining a central axis extending between the first end and the second end; a cap attached to the neck region to close the second end of the elongate body and enclose a cavity within the body, the cap comprising an end wall including an opening therethrough communicating with the cavity, and a shoulder surrounding the opening on an interior surface of the cap; and a sealing member bonded within the opening, the sealing member having a bond strength sufficient to seal the opening while allowing the sealing member to be displaced out of the opening when an actuator pin is advanced into the opening to open the opening, the cavity filled with pressurized fluid.

In accordance with still another example, a gas canister is provided that includes an elongate body comprising a barrel region defining a first diameter, an enclosed first end, and a neck region extending from the barrel region to an open second end defining an end wall, the elongate body defining a central axis extending between the first end and the second end; a cap attached to the neck region to close the second end of the elongate body and enclose a cavity within the body, the cap comprising an end wall including an opening therethrough communicating with the cavity, and a shoulder surrounding the opening on an interior surface of the cap; and a scaling member comprising a cylindrical plug received through the opening to seal the opening, the plug secured with sufficient friction to seal the opening while allowing the plug to be displaced out of the opening when an actuator pin is advanced into the opening to open the opening, the cavity filled with pressurized fluid.

In accordance with yet another example, a gas canister is provided that includes an elongate body comprising a barrel region defining a first diameter, an enclosed first end, and a neck region extending from the barrel region to an open second end defining an end wall, the elongate body defining a central axis extending between the first end and the second end; a cap attached to the neck region to close the second end of the elongate body and enclose a cavity within the body, the cap comprising an end wall including an opening therethrough communicating with the cavity, and a seat surrounding the opening on an interior of the end wall; and a sealing member slidable axially within the neck region adjacent the cap, the scaling member biased to an outer position where the sealing member seals the opening and movable to an inner position away from the cap to open the opening, the cavity filled with pressurized fluid.

In accordance with another example, a gas-actuated tool is provided that includes a housing comprising a functional portion and an actuator portion including a chamber; a canister within the chamber comprising an elongate body comprising an enclosed first end and an open second end, a cap welded to the open second end of the elongate body and including an opening communicating with an interior cavity of the canister filled with pressurized gas, and a scaling member sealing the opening; a carriage carrying an opener pin movable within the housing from a first position where the pin is spaced from the opening of the canister and a second position where the pin at least partially enters the opening; and an actuator on the actuator portion coupled to the carriage such that activation of the actuator causes the carriage to move from the first position to the second position such that the pin displaces the sealing member to open the opening, thereby releasing pressurized gas from the canister into one or more passages within the housing to provide energy to the functional portion.

In accordance with another example, a method is provided for making a canister that includes providing an elongate body comprising a barrel region, an enclosed first end, and a neck region extending from the barrel region to an open second end defining an end wall, the elongate body defining a central axis extending between the first end and the second end; providing a cap comprising an outer flange and an opening therethrough surrounded by a seat and a sealing member configured to engage the seat to seal the opening; stabilizing the scaling member relative to the cap; introducing pressurized gas into an interior cavity of the elongate body; placing the outer flange against the end wall; and welding the flange to the end wall, thereby attaching the cap to the body to enclose the cavity with the pressurized gas therein.

Other aspects and features of the present invention will become apparent from consideration of the following description taken in conjunction with the accompanying drawings.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1A is a cross-sectional view of an example of an intraocular lens inserter including a single-use gas canister loaded therein.

FIG. 1B is a cross-sectional view of the lens inserter of FIG. 1A with an actuator activated such that a pin opens a seal of the gas canister to deliver pressurized gas from the gas canister to provide an energy source for the lens inserter.

FIG. 1C is a detail showing an example of a pin of an actuator, such as that shown in FIGS. 1A and 1B, which may be used to move a ball sealing an opening in a gas canister to release pressurized gas therein.

FIG. 2 is a cross-sectional view of an example of a gas canister including a cap welded to a body and a sealing member, namely a loose ball, sealing an opening in the cap.

FIG. 3 is a cross-sectional view of a neck region of another gas canister including a cap welded to the neck and a sealing member, namely a ball received in a seat surrounding an opening in the cap, sealing the opening.

FIG. 4 is a cross-sectional view of a neck region of another gas canister including a cap welded to the neck and a sealing member, namely a magnetic ball received in a seat surrounding an opening in the cap, with the ball magnetically secured to the cap to seal the opening.

FIGS. 5A-5C show exemplary methods for filling a gas canister including a magnetic ball such as that shown in FIG. 4.

FIG. 6 is a cross-sectional view of a neck region of another gas canister including a cap welded to the neck and a sealing member, namely a poppet engaged against a seat surrounding an opening in the cap, sealing the opening.

FIG. 7 is a cross-sectional view of a neck region of another gas canister including a cap welded to the neck and a sealing member, namely a poppet bonded within an opening in the cap, sealing the opening.

FIG. 8 is a cross-sectional view of an example of a gas canister including a cap welded to a body and a sealing member, namely a spring-biased poppet, sealing an opening in the cap.

FIG. 9 is a cross-sectional view of yet another example of a gas canister including a cap welded to a body and a sealing member, namely a spring-biased poppet, sealing an opening in the cap.

FIG. 9A is a detail of the poppet and cap of the gas canister shown in FIG. 9.

FIG. 10 is a cross-sectional view of still another example of a gas canister including a cap welded to a body and a sealing member, namely a spring-biased poppet, sealing an opening in the cap.

FIG. 11A is a cross-sectional view of a neck region of another gas canister including a cap welded to the neck and a sealing member, namely a ball carried within a ball cage, sealing the opening.

FIG. 11B is a perspective of a ball cage that may be included in the gas canister of FIG. 11A.

FIG. 12A is a cross-sectional view of a neck region of still another gas canister including a cap welded to the neck and a sealing member, namely a ball carried within a ball cage, sealing the opening.

FIG. 12B is a perspective of a ball cage that may be included in the gas canister of FIG. 12A.

FIG. 13 is a cross-sectional view of a neck region of yet another gas canister including a cap welded to the neck and a sealing member, namely a plug with an O-ring, sealing the opening.

FIG. 14 is a cross-sectional view of another example of a gas canister including caps welded onto opposite ends of a body of the gas canister.

The drawings are not intended to be limiting in any way, and it is contemplated that various examples of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

Before the examples are described, it is to be understood that the invention is not limited to particular examples described, as such may, of course, vary. It is also to be understood that the terminology used herein is for the purpose of describing particular examples only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials are now described.

It must be noted that as used herein and in the appended claims, the singular forms “a,” “an,” and “the” include plural referents unless the context clearly dictates otherwise. Thus, for example, reference to “a compound” includes a plurality of such compounds and reference to “the polymer” includes reference to one or more polymers and equivalents thereof known to those skilled in the art, and so forth.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

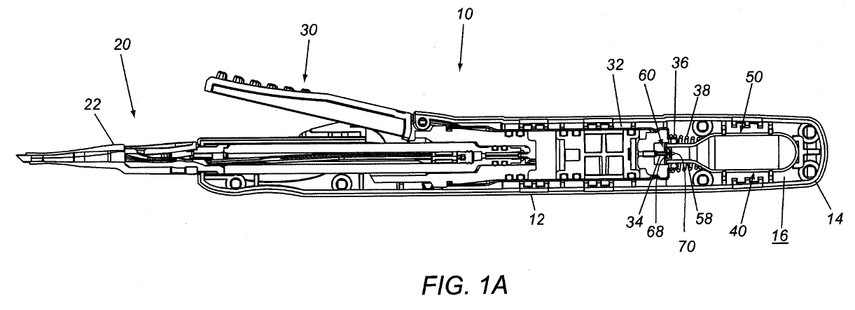

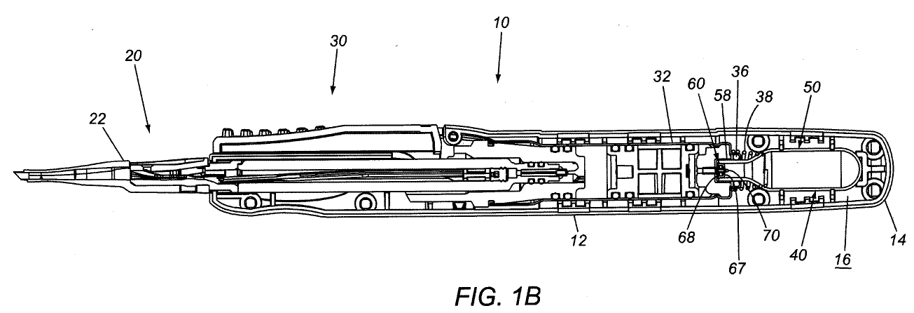

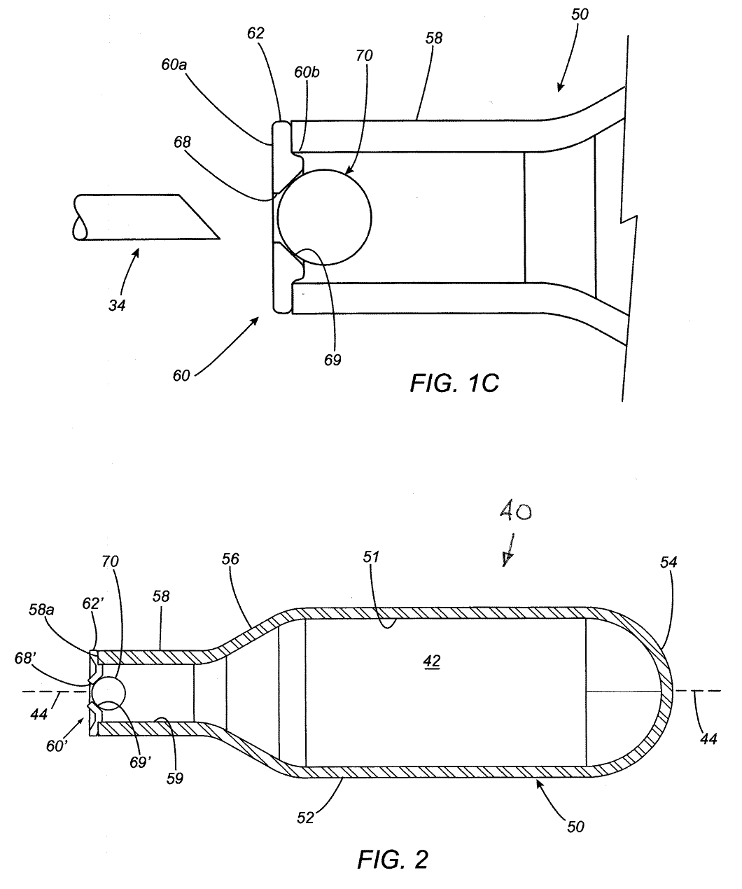

Turning to the drawings, FIGS. 1A and 1B show an example of an intraocular lens (IOL) inserter 10 that includes a lens delivery portion 20, an actuator 30, and a drive mechanism including an energy device, e.g., canister 40 (which may be any of the canisters described herein). The intraocular lens inserter 10 may include a main body portion 12, which includes various cavities, recesses, and conduits, e.g., for providing communication between the canister 40 and the lens delivery portion 20, e.g., for delivering a lens (not shown) from a lens compartment 22 loaded into or onto, secured to, or otherwise forming a part of the lens delivery portion 20, e.g., as described in U.S. Publication No. 2015/0282928, the entire disclosure of which is expressly incorporated by reference herein. Alternatively, the actuator 30 and/or energy device, e.g., canister 40, may be provided in other medical devices or tools, which may be actuated by releasing pressurized gas from the canister 40 to actuate a functional portion of the tool, similar to the methods described elsewhere herein. For example, the canister 40 (or other canisters described herein) may be provided in drive mechanisms for various tools, such as self-powered syringes, shunt inserters for glaucoma procedures, syringe plunger pushers for liquid injections, or other tools (not shown), such as those disclosed in U.S. Pat. Nos. 10,716,892, 10,912,883, 11,071,824, and 11,738,154, the entire disclosures of which are expressly incorporated by reference herein.

For example, as shown in FIGS. 1A and 1B, the IOL inserter 10 may be provided with a canister 40 already provided within the housing 12, i.e., secured within chamber 16. Alternatively, the housing 12 may include a removable cap 14 allowing the canister 40 to be removed and replaced with a new canister, if desired, e.g., if at least the housing 12 and/or other portions of the IOL inserter 10 are reusable. In the example shown, the IOL inserter 10 includes a carriage 32 coupled to the actuator 30 and carrying a pin 34. When the canister 40 is loaded into the chamber 16 (e.g., during manufacturing or before use, for example, where the canister 40 may be loaded into the housing 12 via the cap 14 sometime before use), the pin 34 may be disposed adjacent a sealed opening 68 of the canister 40, e.g., sealed by a sealing member, such as a ball 70 shown in FIGS. 1A-IC. In addition, the IOL inserter 10 may include an O-ring or other seal 36 disposed within the chamber 16 adjacent the pin 34, which may slidably engage a neck region 58 of the canister 40, e.g., to provide a substantially fluid-tight seal between the neck region 58 and the fluid passages within the IOL inserter 10.

Optionally, the carriage 32 may be slidably disposed within the main body portion 12, e.g., such that activation of the actuator 30, as shown in FIG. 1B, causes the carriage 32 and pin 34 to move axially, e.g., from the original or distal position shown in FIG. 1A proximally towards the canister 40 to the proximal position shown in FIG. 1B, thereby pushing the sealing member 70 by the pin 34 to open the opening 68 of the canister 40 and allow gas to escape from the canister 40. For example, FIG. 1C shows a pin 34 that may be coupled to an actuator (such as the actuator 30 shown in FIGS. 1A-1B) to press against the sealing member, e.g., ball 70, scaling the opening 68 of the canister 40 to open the canister 40, as described further elsewhere herein.

Optionally, a spring or other biasing mechanism 38 may be provided within the main body portion 12, e.g., within the chamber 16 adjacent the O-ring 36 and/or around the neck region 58 of the canister 40, for biasing the carriage 32 distally towards the distal position. Thus, when the actuator 30 is released, the carriage 32 may automatically return to the distal position and the pin 34 may be withdrawn from the opening 68 allowing the sealing member 70 to reseal the opening 68. Alternatively, once the ball or other sealing member 70 is pushed away from the opening 68, the ball 70 may not return to reseal the opening 68 and the gas within the canister 40 may be released continuously until the canister 40 is empty.

Turning to FIG. 2, an example of a canister 40 is shown that includes a body 50 and a cap 60 welded to the body 50 to provide an enclosed cavity 42 filled with fluid, e.g., carbon dioxide or other pressurized gas. The fluid contained within the enclosed cavity 42 may be used to provide a desired potential energy or discharge force to power a tool or other medical device, such as the IOL inserter 10 shown in FIGS. 1A and 1B, e.g., to advance the lens from the lens delivery portion 20. Alternatively, the canister 40 may be filled with other two-phase gases, such as a hydrofluorocarbon (e.g., HFC-134a), or a single-phase gas, such as nitrogen. As used herein, “pressurized gas” may include a single-phase gas or a two-phase gas, e.g., in which the gas has been at least partially liquefied, and so may include either a gaseous or mixed liquid-gaseous state fluid. The volume of the cavity 42 may be sufficient to provide energy to the medical device, e.g., a discharge force for the IOL inserter 10 that may be substantially constant and/or controlled when the actuator 30 is actuated.

In one example, the cavity 42 may have an interior volume of no more than about 1.8 milliliters (1.8 mL), or not more than about one milliliter (1 mL), e.g., between about 0.5-1.8 mL, or between about 0.68-0.75 mL. However, in other examples, the interior volume of the cavity 42 may be any desired volume. For example, in some instances, the interior volume of the cavity 42 may be greater than 1.8 mL or less than 0.5 mL.

In some examples, the body 50 and cap 60 are formed from stainless steel or other corrosion resistant, desired, or suitable metal, or other material. In some examples, one or both of the body 50 and cap 60 may be formed by one or more of drawing, stamping, machining, casting, molding, and the like. For example, the body 50 may be deep drawn from sheet metal, e.g., a round sheet metal blank of Type 430 stainless steel, using one or more dies and punches (not shown), e.g., to form a main barrel region 52 and enclosed base or first end 54 of the body 50. Additional processing may be used to form a tapered shoulder region 56 and open neck region or second end 58 defining an opening or passage 59 communicating with an interior cavity 51 of the body 50.

For example, the shoulder and neck regions 56, 58 may be formed by necking and the like, such that the neck region 58 has a substantially uniform diameter smaller than the diameter of the main barrel region 52. Alternatively, the neck region 58 may have a diameter similar to the main barrel region 52, i.e., omitting the shoulder region 56. The regions of the body 50 may be substantially radially symmetrical about a central axis 44 of the canister 40 or may have other desired cross-sections. In the example shown, the neck region 58 may terminate in a substantially planar end wall 58a defining a plane substantially perpendicular to the axis 44.

In various examples, the body 50 may have a length between the first end 54 and the end wall 58a of the neck region 58 that is less than about thirty millimeters (30 mm), the outer diameter of the barrel region 52 may be not more than about ten millimeters (10 mm) or not more than about eight millimeters (8 mm), and the outer diameter of the neck region 58 may be not more than about five millimeters (5 mm), or not more than about four millimeters (4 mm). The neck region 58 may have a substantially uniform diameter length between about three to eight millimeters (3-8 mm) or between about four to six millimeters (4-6 mm). However, the provided dimensions and shapes are merely examples. Thus, the various dimensions of the various aspects of the canister 40 may be selected to be any desired dimension. Further, the shapes of the various aspects of the canister may be any desired shape. For example, one or more shapes of one or more aspects of the canister may be radially asymmetrical relative to the central axis 44 of the canister 40.

Similarly, the cap 60 may be stamped, coined, drawn, and/or otherwise processed from another blank, e.g., to define a substantially circular body including an outer edge or flange 62 having a diameter similar to the outer diameter of the neck region 58, e.g., such that the flange 62 of the cap 260 may be placed over and welded directly to the end of the neck region 58, as described elsewhere herein. The cap 60 also includes an opening 68 therethrough and, optionally, a recessed seat 69 surrounding an inner side of the opening 68 for engaging a scaling member, such as the ball 70 as shown in FIG. 1C. In the example shown, the seat 69 may have a concave shape, e.g., defining a portion of a sphere having a diameter similar to or larger than a diameter of the ball 70 to facilitate the ball 70 sealingly engaging the seat 69.

Optionally, in the example shown in FIG. 1C, an outer surface 60a of the cap 60 is substantially flat and an annular shoulder 60b is provided on an inner surface, e.g., surrounding and/or defining the seat 69, which may be sized to be slidably received in the neck region 58 of the body 50. Alternatively, in the example shown in FIG. 2, the cap 60′ may have a nonplanar shape, e.g., including an annular recess around the opening 68′ that defines an inner seat 69′ surrounding the opening 68′ and an outer lip or flange 62′ that may be placed over the end wall 58a of the neck region 58. Optionally, the cap 60 and/or seat 69 may be shaped to provide one or more guide surfaces for guiding the ball 70 into the seat 69. For example, with reference again to FIG. 1C, the inner surface of the cap 60 adjacent the seat 69 (or any of the caps herein) may include a tapered or otherwise shaped lead-in surface such that the ball 70 self-centers as it enters the seat 69 to ensure proper engagement and/or enhanced sealing of the opening 68. In other options, the cap may include other features, e.g., an annular sleeve to position the opening within the neck region, an inner end wall, spacers, and/or projections, similar to other examples herein.

Once formed, the body 50 and cap 60 may be processed as desired, e.g., deburred, have sharp edges broken, and the like, to provide, for example, a desired finish for the components before assembly. The cap 60 may then be substantially permanently attached to the body 50, e.g., by projection welding.

For example, in an exemplary process, the body 50 and cap 60 may be placed in a filling chamber (not shown) and the filling chamber may be filled with carbon dioxide (or other gas) to a desired pressure, thereby filling the interior 51 of the body 50 with the gas. For example, the cap 60 may be positioned immediately adjacent the end wall 58a of the neck region 58, while allowing the gas to pass around the cap 60 and into the neck region 58. Optionally, the filling chamber may be controlled to a desired temperature that is below the saturation temperature of the gas at filling pressure to condense the gas in the canister 40, thus filling the canister 40 with liquefied gas.

Once filled, the cap 60 may be welded to the neck region 58 to close the interior 51 and seal the liquefied gas within the resulting canister 40. For example, as shown in FIG. 1C, with the ball 70 seated against the seat 69, the cap 60 may be placed against the end wall 58a of the neck region 58 and the outer flange 62 welded to the neck region 58. Optionally, the ball 70 may be temporarily spaced apart from the cap 60 during welding, e.g., if the ball 70 includes materials that may be damaged by heat from the welding process, as described further elsewhere herein. Alternatively, the interior 51 may be filled after welding the cap 60 to the body 50, e.g., by moving the ball 70 out of the opening 68 and repositioning the ball 70 to seal the opening 68 after filling, as described elsewhere herein.

Optionally, the cap 60 may include an annular projection (not shown) on inner surface of the cap adjacent the outer flange 62, which may contact the end wall 58a of the neck region 58. In this manner, when the cap 60 is welded to the body 50, the resulting weld may be formed between the projection and the end wall 58a of the neck region 58. For example, in an exemplary projection welding procedure, the body 50 may be coupled to ground (or one electrode) within the filling chamber and an opposite electrode may be placed against the outer surface 60a of the cap 60, thereby holding the projection against the end wall 58a of the neck region 58. Once the body 50 and cap 60 are engaged, electrical energy may be applied to the electrode, thereby forming a weld to attach the cap 60 and seal the resulting interior cavity 42 of the canister 40 with a desired volume of liquid CO2 therein.

In the example shown in FIG. 1C, the ball 70 may be loose relative to the cap 60 such that internal pressure within the interior 42 pushes the ball 70 against the seat 69 to seal the opening 68, e.g., when the canister 40 is removed from the filling chamber. Exemplary methods for holding or otherwise positioning the ball 70 (or other sealing members herein) during filling and/or while welding the cap 60 are described elsewhere herein.

When the canister 40 is removed from the filling chamber, the CO2 or other gas may return to its gaseous state or a mixed liquid-gaseous state, thereby providing a desired pressure within the cavity 42. In various examples, the mass of CO2 provided within the canister 40 after filling may be about six hundred milligrams (600 mg) or less, or about five hundred milligrams (500 mg) or less and/or having a resulting density between about 0.50-1.0 kg/L or between about 0.50-0.75 kg/L. In still other examples, the mass and/or density of the fluid, such as CO2, within the canister 40 may be selected to be any desired mass or density. Further, it will be appreciated that gases or fluids other than CO2 may be used to fill the canister 40 that provide a desired pressure and/or discharge force during use, as desired.

Optionally, in any of the examples described herein, after a canister (such as canister 40) is removed from the filling chamber, the canister 40 may be weighed to confirm that a desired amount of gas has been loaded into the canister 40. For example, the mass and pressure of the gas may be determined by comparing the mass after filling with the original mass of the body 50 and cap 60, e.g., to confirm that the mass and pressure lie within desired tolerances. For example, it may be desirable to confirm that the pressure within the canister 40 does not exceed a desired maximum density (e.g., 0.75 mg/mL), which may otherwise result in the canister 40 exceeding regulatory standards and/or safe pressures. Again, the density and/or mass of the fluid contained within the canister 40 may be any desired density or mass.

During subsequent storage of the canister 40 (e.g., during its normal shelf life before being loaded into and used with a medical device), it may be desirable to confirm that gas has not leaked from the canister 40 during its intended shelf life. For example, the canister 40 may be weighed again, e.g., at one or more desired intervals, to ensure that the gas has not leaked from the canister 40. Alternatively, other methods may be used to confirm that gas remains within the canister 40, e.g., mass spectrometry and the like. For example, despite the cap 60 being welded to the body 50, gas may still leak from the canister 40 and, therefore, the canister 40 may be weighed to ensure that an adequate fill of gas remains to ensure sufficient gas through the stroke of the medical device into which the canister 40 is to be loaded. One approach is to weigh the canister 40 following filling; expose the canister 40 to elevated temperatures to raise the internal pressure to accelerate any leakage that may be present; reweigh the canister 40 to determine if the mass has been reduced indicating the leak; and then extrapolate the leakage rate over the shelf life to ensure that sufficient gas will remain in the canister 40 over the shelf life of the product.

Forming the body 50 and cap 60 from stainless steel may provide corrosion protection for the resulting canister 40 over its target shelf life. Galvanized steel has been used for conventional gas canisters to provide corrosion protection, but may be inadequate for the canister 40. In particular, metallic plating, e.g., zinc, cannot be applied before welding the cap 60 to the body 50 since the plating would be lost at the weld, thereby compromising the corrosion protection. If additional plating were applied to the weld, the plating may not have a uniform thickness (on each canister and between different canisters). However, it will be appreciated that any appropriate and/or desired material, such as metal, plastic, and/or composite materials, may be used instead of stainless steel or galvanized steel.

Such variances in plating (before or after welding) may not meet the required tolerances to ensure that the mass and/or pressure of the gas within the finished cylinder falls within the desired range. Stainless steel can be formed to higher tolerances since no such plating is needed, thereby ensuring that the properties of the gas may be accurately determined after filling and/or over the shelf life of the canister. Additional information related to methods for making the canisters described herein may be found in U.S. Pat. No. 10,610,351, the entire disclosure of which is expressly incorporated by reference herein.

With continued reference to FIG. 1C, the ball 70 (or other sealing members herein) may be formed from a variety of materials capable of sealing the opening 68 when the ball 70 is fully engaged with the seat 69. For example, the ball 70 may be formed from rigid and/or hard material, e.g., metal, such as stainless steel, or alternatively, from soft and/or pliable material, e.g., elastomers and/or plastic materials, which may at least partially deform when engaged with the seat 69. The ball 70 may be formed using various processes, such as molding, casting, machining, stamping, laser cutting, and the like, to provide a desired size and/or shape. For example, the ball 70 may have a substantially uniform spherical shape having a diameter smaller than the diameter of the neck region 58 and larger than the diameter of the opening 68, e.g., between about 0.5 to 2.5 millimeters, e.g., about two millimeters (2.0 mm).

Optionally, one or more coatings may be applied to enhance corrosion resistance and/or durability of the ball 70. For example, in one construction, the ball 70 may be formed from metal, e.g., steel, with a parylene coating applied around the outer surface.

In another option, one or more coatings and/or outer surface finishes may be applied to the ball 70 if desired, e.g., to facilitate sealing the opening 68. For example, if the ball 70 is formed from metal or other rigid material, a relatively soft material may be applied around the outer surface, e.g., an elastomer or other plastic, to provide some compliance when engaged with the seat 68, e.g., to enhance sealing. In addition or alternatively, a relatively soft material may be applied to the surface(s) of the seat 69 to enhance sealing. For example, an epoxy or other sealing material (e.g., MasterBond UV15X) may be applied to the surface(s) of the seat 69, e.g., by one or more of masked dipping, masked spraying, or applying a die-cut adhesive layer.

In the examples shown in FIGS. 1C and 2, e.g., including a loose ball 70 within the canister 40, the filling process may be completed with the body 50 maintained vertically with the neck region 58 oriented vertically downward. In this arrangement, the cap 60 may be welded to the body 50 before filling and, during filling, the ball 70 may be directed away from the opening 68, e.g., by inserting a tool or fixture (not shown) into the opening 68 at least initially to facilitate introducing gas into the interior 51 of the body 50. The tool may be removed once sufficient internal pressure is generated, e.g., manually or automatically, allowing the pressure and/or gravity to direct the ball 70 downward towards the opening 68. This arrangement also allows the cap 60 to be welded to the body 50 before filling, since the ball 70 may be easily positioned away from the cap 60, e.g., if desired, to protect the ball 70 if formed from soft materials and/or materials that may be damaged if exposed to the welding process. For example, the cap 60 may be welded to the body 50 with the neck oriented vertically upward allowing the ball 70 to fall to the bottom of the body 50 away from the neck region 58.

Alternatively, the canister 40 may be filled with the neck region 58 oriented vertically upward before welding the cap 60 to the body 50, e.g., with the cap 60 adjacent to the neck region 58 such that gas is introduced around the cap 60, whereupon the cap 60 and ball 70 may be seated on the neck region 58 and welded with internal pressure preventing the ball 70 from falling into the interior 51.

Optionally, the ball 70 may be secured to the seat 69, e.g., by bonding with adhesive and the like, to allow the cap 60 to be welded to the body 50 with the neck region 58 oriented vertically upward. For example, a UV adhesive may be applied to the seat 69 and/or the portion of the ball 70 to be received in the seat 69, and the ball 70 may be positioned in the seat 69 such that any excess adhesive is squeezed through the opening 68 (and may be easily wiped away or otherwise removed). In exemplary methods, the adhesive may be applied by one or more of screen printing, transfer printing, using a CNC applicator, and the like. The adhesive may then be cured, e.g., by exposing the lower surface of the cap 60 to ultraviolet light, thereby bonding the ball 70 to the cap 60.

The adhesive may be sufficiently durable to remain in place after the cap 60 is welded to the body 50, e.g., such that the adhesive provides an enhanced seal with the ball 60 secured in the seat 69. The adhesive may be spaced sufficient distance from the outer flange 62 of the cap 60 such that the welding process does not adversely impact the bond strength of the adhesive. Alternatively, if the cap 60 is welded after filling, the welding process may reduce the bond strength or destroy the adhesive and the internal gas pressure may maintain the ball 70 within the seat 60 to seal the opening 68, e.g., similar to a loose ball or sealing member.

Alternatively, a plate or other tool (not shown) may be used to temporarily secure the ball 70 to the cap 60, e.g., during filling and/or welding. For example, with reference to FIG. 1C, a plate may be positioned against the outer surface 60a of the cap 60 that includes a circular extension sized to extend into the opening 68 and/or otherwise contact the ball 70 positioned in the seat 69. The extension may include a weak adhesive that may have sufficient bond strength to prevent the ball 70 from moving during filling and/or welding. Once the cap 60 is welded and the canister filled, the plate may be removed by breaking the bond and removing the extension from the opening 68 with the ball 70 remaining seated to seal the opening 68 based on internal pressure within the canister 40.

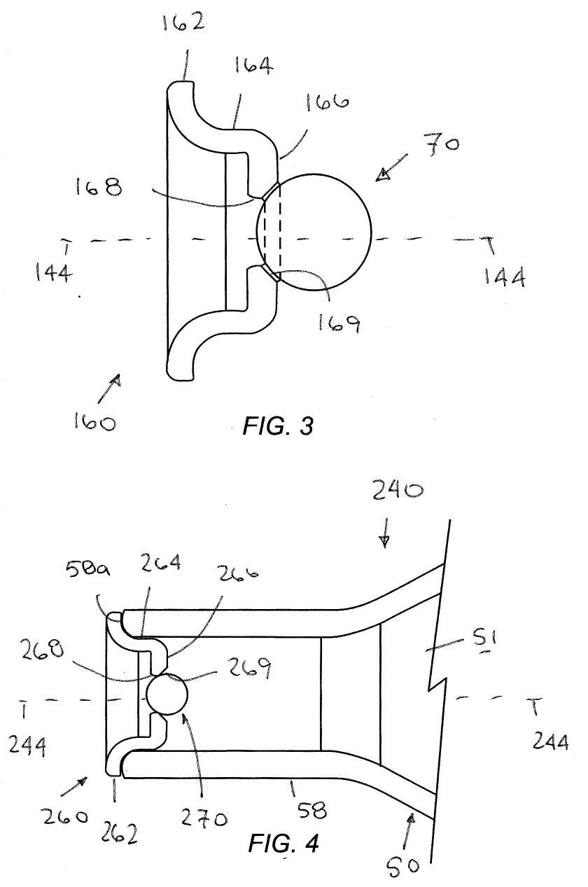

Turning to FIG. 3, another example of a cap 160 is shown that includes an opening 168 and seat 169 for receiving a ball 70 (or other sealing member), which may be welded to the neck of a body (not shown) to provide a canister. Unlike the cap 60, the cap 160 includes an annular outer flange 162, e.g., sized to be received over the end wall of the neck region, and an annular body or sleeve 164 extending from the flange 162, e.g., along axis 144, to an inner end wall 166 that includes the opening 168 and seat 169. When the flange 162 is positioned against the end wall of the neck region, the sleeve 164 extends into the neck to position the end wall 166 and, consequently, the opening 168 and seat 169, within the neck region, e.g., similar to the cap 260 shown in FIG. 4.

The sleeve 164 may have an outer diameter smaller than the neck region of the body such that the sleeve 164 may be inserted into the neck region while providing a desired clearance between the sleeve 164 and the neck region, which may facilitate projection welding the flange 162 to the neck region of the body. Optionally, one or more tabs or other spacers (not shown) may be provided on the outer surface of the sleeve 164 if desired, e.g., to guide the cap 160 into the neck region and/or provide a uniform clearance around the sleeve 164. The cap 160 and/or ball 70 may be otherwise constructed and/or include any of the optional features described elsewhere herein for the other caps.

Optionally, the ball 70 may be bonded to the set 169, e.g., using one or more adhesives, which may secure the ball 70 during filling and/or welding, and/or may have sufficient bond strength to secure the ball 70 until an opener pin (not shown) is inserted into the opening 168 to push the ball 70 and open the opening 168 to release pressurized gas, similar to other canisters and tools described herein and in the references incorporated by reference herein.

Turning to FIG. 4, another example of a cap 260 and sealing member 270 are shown that may be welded or otherwise attached to a neck region 58 of a body 50 to provide a gas canister 240, generally similar to other canisters herein. As shown, the cap 260 includes an annular outer flange 262, an annular sleeve 264 extending from the outer flange 262 to an inner end wall 266 including an opening 268 and seat 269, which may be constructed generally similar to other caps herein. The sealing member 270 may include a ball sized to be engaged within the seat 269 to seal the opening 268, also generally similar to other sealing members herein.

However, unlike other examples herein, the ball 270 and cap 260 include cooperating ferromagnetic materials that attract the ball 270 to the seat 269. For example, the ball 270 may be formed from a magnet and at least the seat 269 and/or end wall 266 of the cap 260 includes material to which the magnet is attracted. For example, the seat 269 may include a coating or embedded elements (not shown) including one or more of iron, nickel, cobalt, or other ferromagnetic materials that would attract the ball 270 including a magnet. In this example, the ball 270 may include an outer coating, e.g., formed from elastomeric or other material, to cover the underlying magnetic material and/or to provide a desired outer surface finish for the ball 270. In addition, the coating may provide a softer and/or more pliable outer surface for the ball 270, e.g., if the underlying material is rigid, which may enhance scaling when engaged with the seat 269.

During filling and/or welding of the cap 260 to the body 50, if desired, the ball 270 may be directed away from the seat 269, e.g., to open the opening 268 for filling and/or to move the ball 270 away from the cap 260 to reduce exposure to heat during welding. For example, during filling of the canister 240, the cap 260 with the ball 270 received in the seat 269 may be positioned adjacent the neck region 58 with the outer flange 262 spaced apart from the end wall 58a, e.g., such that gas may be introduced into the interior 51 around the cap 260. Once the interior 51 is filled, the outer flange 262 may be seated against the end wall 58a and welded together, e.g., similar to other caps described herein.

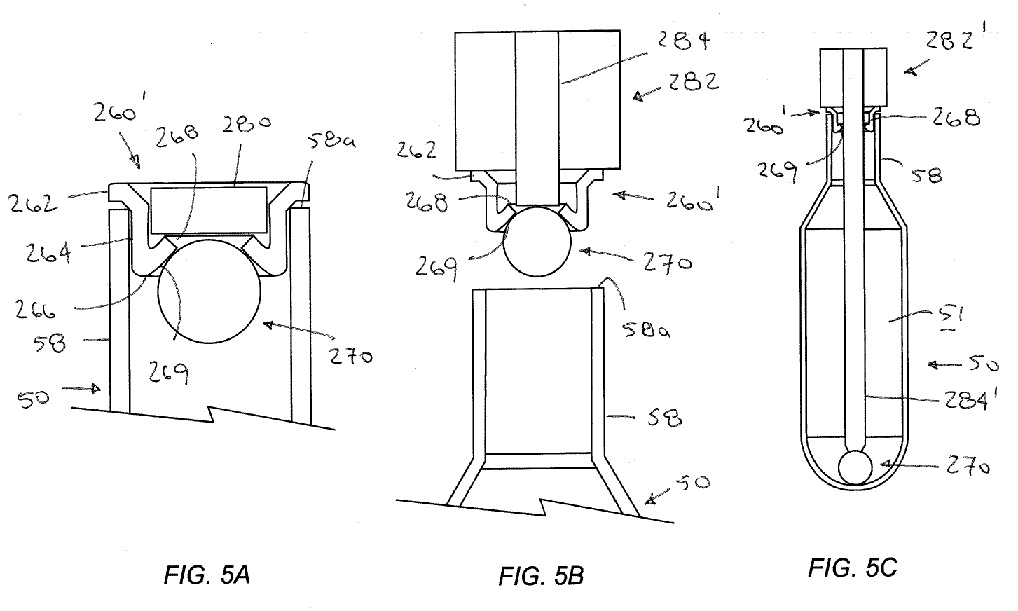

Turning to FIG. 5A, alternatively, a sealing member, e.g., ball 270, may be provided that includes ferromagnetic material without providing ferromagnetic material on the cap 260.′ In this alternative, the ball 270 may remain loose within the interior of the canister 240′, however, to facilitate filling and/or welding the cap 260′ to the body 50, a separate magnetic member 280 may be provided that may be positioned adjacent the cap 260,′ e.g., within a recess 265 defined by the annular sleeve 264, to attract the ball 270 into the seat 269. For example, with the ball 270 stabilized, the cap 260′ may be positioned within the neck region 58a and pressurized fluid introduced around the cap 260′ to fill the canister 240′ after which the cap 260′ may be welded to the body 50. The magnetic member 280 may then be removed to release the ball 270, which may remain seated against the seat 269 to seal the opening 268. In this alternative, one or both of the ball 270 or the magnetic member 280 may include a magnet or one of them may only include ferromagnetic material attracted to the magnet on the other of the ball 270 and the magnetic member 280.

Alternatively, with the cap 260′ welded to the body 50, the canister 240′ may be oriented with the neck region 58a vertically upward within a filling station such that the ball 270 falls to the bottom of the body 50. Pressurized fluid may be introduced through the opening 268 and, once the canister 240′ is filled, the magnetic member 280 may be positioned within the recess of the cap 260′ to attract the ball 270 upwards into engagement with the seat 269 and, when external pressure is removed, the internal pressure will engage the ball 270 with the seat 269 to seal the opening 268.

Alternatively, as shown in FIG. 5B, during filling, the cap 260′ may be mounted to an electrode 282, which includes a magnetic member 284 aligned with the opening 268 to attract the ball 270 into the seat 269. The cap 260′ may be positioned adjacent the neck region 58 of the body 50 during filling to allow gas to be introduced around the cap 260,′ whereupon the cap 260′ may be positioned against the end wall 58a of the neck region 58 and the electrode 282 activated to weld the outer flange 262 to the neck region 58, similar to other canisters and methods described elsewhere herein.

In another alternative, shown in FIG. 5C, an electrode 282′ may be provided that includes an elongate magnetic member 284′ that is movable relative to the electrode 282 and sized to pass through the opening 268 in the cap 260.′ For example, when the canister 240′ is initially positioned in a filling station, the cap 260′ may be mounted to the electrode 282,′ and the magnetic member 284′ may be advanced through the opening 268, thereby coupling the ball 270 to the magnetic member 284.′ As shown, the magnetic member 284′ may be advanced to move the ball 270 away from the opening 268, e.g., to the bottom of the body 50. During filling, gas pressure within the interior 51 of the body 50 and/or an actuator may cause the magnetic member 284,′ and consequently, the ball 270, to move upwardly until the interior 51 is filled, automatically or manually. After complete filling, the magnetic member 284′ may be removed through the opening 268 to allow the ball 270 to engage the seat 269 and seal the opening 268. Thus, in this alternative, the cap 260′ may be welded to the body 50 before filling, with the canister 240′ filled through the opening 268 around the magnetic member 284,′ or the cap 260′ may be spaced apart from the neck region 58 to allow filling around the cap 260′ if desired, similar to other methods described elsewhere herein.

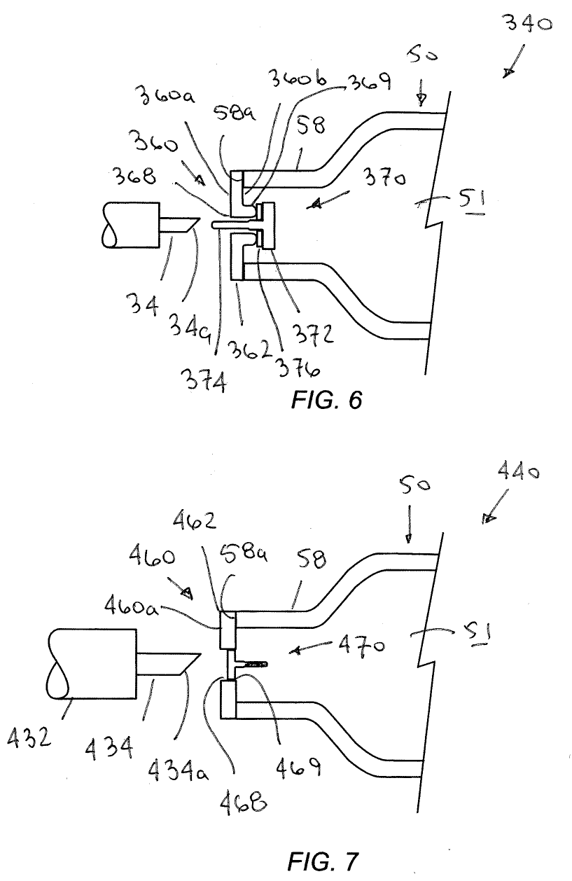

Turning to FIG. 6, another example of a cap 360 is shown that may be welded or otherwise permanently attached to a body 50 to provide a canister 340. In this example, the cap 360 includes a substantially flat outer surface 360a surrounding an opening 368 and an outer edge or flange 372 sized to be placed against an end wall 58a of the neck region 58 of a body 50, similar to other canisters described elsewhere herein. It will be appreciated, that, alternatively, as with other canisters herein, the cap 360 may include an annular sleeve extending from an annular outer flange and/or an end wall within the neck region (not shown), rather than providing a flat cap 360, if desired.

In this example, the cap 360 includes a sealing member, namely a poppet 370, e.g., including a substantially flat disk 372 having an outer diameter larger than the opening 368 in the cap 360, such that the poppet 370 may be seated against the cap 360 to seal the opening 368. In addition, the cap 360 includes an annular shoulder 369 surrounding the opening 368 on an inner surface of the cap 360 against which the disk 372 may be seated to seal the opening 368. A filament, shaft, or other elongate member 374 may extend from the poppet 370, e.g., from a central location on the disk 372, that is sized to be received through the opening 368. During assembly and/or filling, tension may be applied to the elongate member 374, as desired, to secure the disk 374 against the shoulder 369 around the opening 368.

For example, the elongate member 374 may be used to stabilize the disk 372 while gas is introduced into the interior 51 around the cap 360, whereupon the cap 360 may be welded to the neck region 58 (similar to other caps herein). Alternatively, with the cap 360 welded to the neck region 58, the disk 372 may be separated from the shoulder 369 to allow the interior 51 to be filled through the opening 368, whereupon the elongate member 374 may be pulled to engage the disk 372 against the shoulder 369 to seal the opening 368.

Once the canister 340 is completed, i.e., filled with pressurized gas and with the cap 360 welded to the body 50, the elongate member 374 may be severed, e.g., adjacent the outer surface 360a of the cap 360 and the internal pressure may maintain the disk 372 sealed against the shoulder 369. The resulting poppet 370 may include a relatively short stem from the remaining elongate member 374 that extends through the opening 368 or. Alternatively, the elongate member may be severed immediately adjacent the outer surface of the disk 372 such that the stem is omitted.

Optionally, the disk 372 may include a sealing material 376 on its outer surface, e.g., an elastomeric material, such as silicone, to enhance sealing between the disk 372 and the shoulder 369, e.g., if the disk 372 is formed from metal or other rigid material. Alternatively, the entire disk 372 may be formed from material providing some conformance to enhance scaling the opening 368 while having low permeability to prevent leakage of gas from the canister 340, such as PEEK or PCTFE. The disk 372 may be formed using various methods, such as molding, extruding, casting, machining, laser cutting, and the like.

As shown in FIG. 6, once the canister 340 is loaded into a tool or other medical device (not shown), an opener pin 34 may be advanced through the opening 368 to push the scaling member 360 away from the shoulder 369, thereby opening the opening 368 to allow pressurized gas to escape from the canister 340 to provide energy to the medical device, similar to other examples herein. If the poppet 360 includes a stem remaining from the elongate member 382, the pin 34 may have a hollow cylindrical shape or otherwise include a passage that accommodates receiving the stem therein when the pin 34 is advanced to displace the poppet 360. Optionally, a similar elongate member may be provided on any of the other scaling members, if desired, such as the loose ball 70 shown in FIGS. 1C and 2, which may be manipulated to move the ball 70 away from and/or against the seat 69. The elongate member may be severed once the canister 40 is filled and the ball 70 is engaged with the seat 69 due to internal pressure within the canister 40.

Returning to FIG. 6, one advantage of the sealing member 360 is that, if the pin 34 has a beveled or angled tip 34a, when the pin 34 is advanced through the opening 368, the tip 34a may cause the disk 372 to pivot diagonally away from the shoulder 369, which may reduce the force necessary to move the sealing member 370 to release the pressurized gas. Further, such angled displacement may reduce the risk of the disk 372 returning to seal the opening 368, thereby allowing continuous release of the pressurized gas once the disk 372 is initially displaced.

Turning to FIG. 7, still another example of a cap 460 is shown that may be welded or otherwise permanently attached to a body 50 to provide a canister 440. In this example, the cap 460 includes a substantially flat outer surface 460a surrounding an opening 468 and an outer edge or flange 472 sized to be placed against an end wall 58a of the neck region 58 of a body 50, similar to other canisters described elsewhere herein. It will be appreciated, that, alternatively, the cap 460 may include an annular sleeve extending from an annular outer flange and/or an end wall within the neck region (not shown), rather than providing a flat cap 460, if desired.

In this example, the cap 460 includes a relative small poppet 470 received within the opening 468. The poppet 470 may include a circular, flat disk or other body sized to be received entirely within the opening 468. For example, the poppet 470 may be secured within the opening 468 by bonding with adhesive, fusing the material of the poppet 470 to the surrounding material of the cap 460, and the like. The adhesive may have sufficient bond strength to provide a fluid-tight seal for the opening 468 under the internal pressures encountered by the pressurized gas that fills the canister 440.

During use, the canister 440 may be provided within a tool or other medical device that includes a carriage 432 and opener pin 434, which may be initially spaced apart from the poppet 468. The opener pin 434 may be sized to pass through the opening 468 such that, when an actuator displaces the carriage 432 and pin 434 relative to the cap 460, the pin 434 may enter the opening 468 and push the poppet 470 at least partially out of the opening 468 to release the pressurized gas. In the example shown, the pin 434 may include a beveled or angled tip 434a, which may provide a mechanical advantage pushing the poppet 470 at least partially out of the opening 468 to release the pressurized gas.

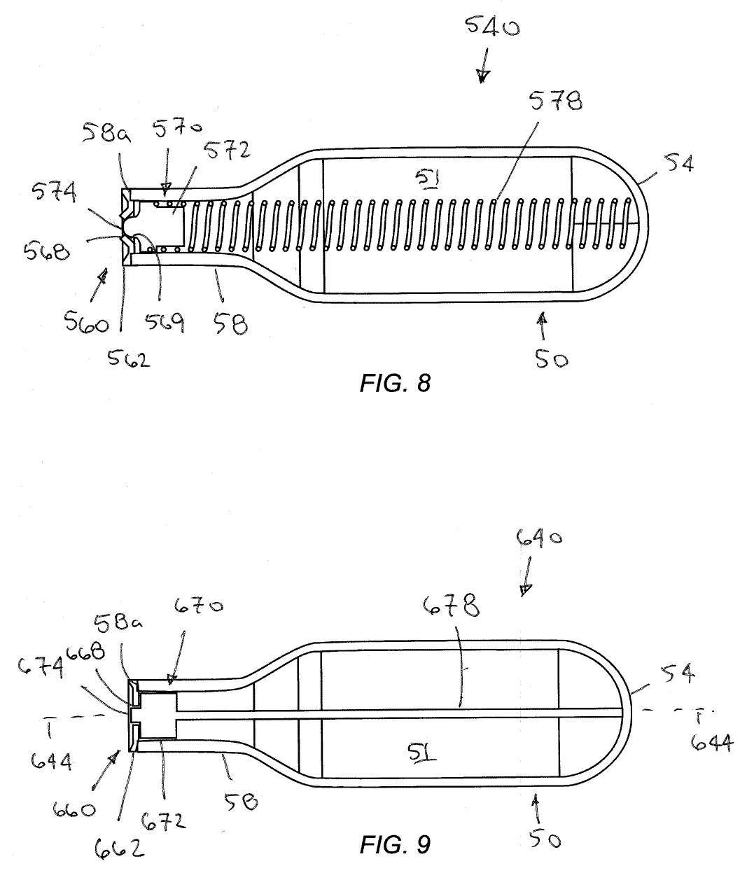

Turning to FIG. 8, another example of a gas canister 540 is shown that generally includes a body 50 and a cap 560 welded to a neck region 58 of the body 50, similar to other canisters herein. The cap 560 generally includes an outer flange 562 sized to contact an end wall 58a of the neck region 58 and an opening 568 therethrough communicating with the interior 51 of the body 50. In the example shown, the cap 560 includes an annular recess surrounding the opening 568 to at least partially define an internal seat 569.

The gas canister 540 also includes a sealing member, namely poppet 570, that includes a cylindrical body 572 terminating in a tip 574 sized to be at least partially received in the opening 568 and/or seat 569. For example, as shown, the tip 574 may include a nipple extending from the cylindrical body 572 sized to be seated in the opening 568, e.g., to seal the opening 568, similar to other sealing members herein. For example, the tip 574 may define a partially spherical surface and the seat 569 may include a similarly shaped concave surface sized to accommodate receiving the tip 574.

Unlike other examples herein, the sealing member 570 includes a spring 578 coupled between the cylindrical body 572 and the lower surface 54 of the body 50, e.g., to bias the sealing member 570 to enhance sealing the opening 568. In the example shown, the spring is a compression spring that has a relaxed length longer than the length of the body 50, e.g., such that when the poppet 570 engages the cap 560, potential energy remains within the spring 578 to enhance sealing.

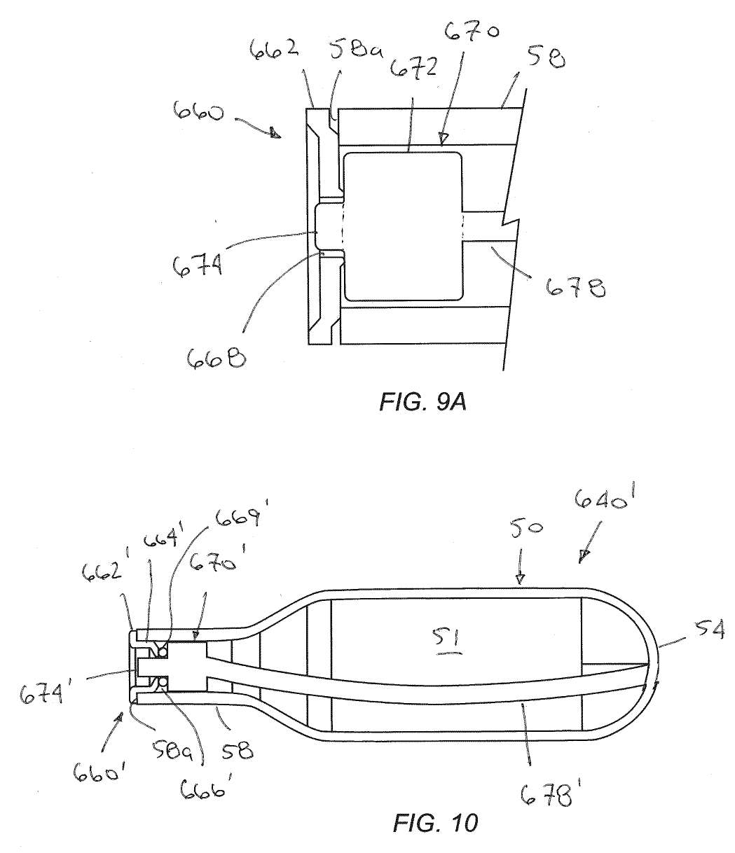

Alternatively, as shown in FIG. 9, a poppet 670 may be provided that includes a tail or tension element 678 extending from the poppet 670 to the lower surface 54 of the body 50. In this alternative, the tail 678 may be biased to extend axially along a longitudinal axis 644 of the canister with the poppet 670 seated against the cap 660. In this alternative, the poppet 670 may include a cylindrical tip 674 sized to be received within and/or through the opening 668 in the cap 660 to seal the opening, e.g., as best seen in FIG. 9A. When the poppet 670 is directed axially away from the cap 660, the tail 678 may be subjected to axial compression and may be biased to extend axially back to the configuration shown in FIG. 9, which may enhance scaling the opening 668.

In a further alternative, shown in FIG. 10, a poppet 670′ may be provided that includes a tail or tension member 678′ that is subjected to axial compression even when the poppet 670′ is fully seated against the cap 660′ such that the tail 678′ has a curved shape between the bottom 54 of the body 50 and the cap 660′ (which, in this example, includes an annular outer flange 662, a sleeve 664′, and an internal end wall 666′ including the opening 668′). Optionally, as shown in FIG. 10, an O-ring 671′ may be provided on the tip 674′ of the poppet 670′, which may further enhance sealing the opening 668′ when the tip 674′ is received within the opening 668.′ Such an O-ring may be provided on other sealing members herein, if desired. When the poppet 670′ is pushed into the body 50, e.g., when an opener pin (not shown) is advanced into the opening 668,′ the tail 678′ may be subjected to increased axial compression further bending the tail 678,′ such that, when the pin is removed, the tail 678′ may be biased to at least partially straighten to cause the poppet 670′ to automatically advance to rescal the opening 668.′

Optionally, with any of the canisters 540, 640, 640′, the cap 560, 660, 660′ may be welded to the body 50 before filling, and the poppet 560, 660, 660′ may be displaced after positioning the canister within a filling station (not shown) to allow gas to be introduced through the opening 568, 660, 668′ to fill the canister 540, 640, 640.′ Once filled, the poppet 560, 660, 660′ may be released to seal the opening 568, 668, 668′, e.g., until the canister 540, 640, 640′ is loaded into a tool or other medical device and an actuator is activated to direct an opener pin into the opening 568, 668, 668,′ similar to other devices herein, although the opening 568, 668, 668′ may be automatically rescaled if the opener pin is withdrawn.

Although the canisters 540, 640, 640′ are generally described as single-use, similar to other canisters described herein, optionally, given the biased poppets, 560, 660, 660,′ the canisters may also be reusable. For example, after being used to deliver pressurized gas to power a tool or medical device, the canisters 540, 640, 640′ may be removed from the device and returned to a filling station (e.g., after cleaning and/or sterilization), where the poppets 560, 660, 660′ may be displaced again to refill the canisters 540, 640, 640′ for use in a new device.

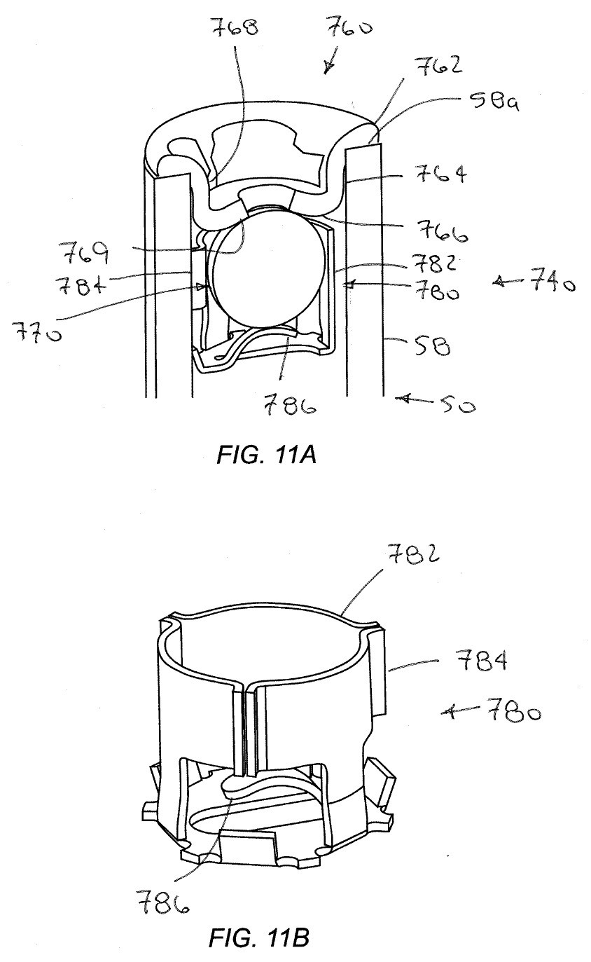

Turning to FIGS. 11A and 11B, another example of a gas canister 740 is shown that generally includes a body 50 and a cap 760 welded to a neck region 58 of the body 50, similar to other canisters herein. The cap 760 includes an outer flange 762 sized to contact an end wall 58a of the neck region 58, an annular sleeve 764 extending the outer flange 762 to an end wall 764 including an opening 768 therethrough communicating with the interior of the body 50. Alternatively, the cap 760 may have a substantially flat or other configuration, similar to other caps herein. A sealing member, namely ball 770 is provided that is sized to engage a seat 769 surrounding the opening 768, e.g., to seal the opening 768 once the canister 740 is filled with pressurized gas, similar to other canisters herein.

Unlike other canisters, a cage 780 is provided within the neck region 58 of the body 50 that is configured to receive the ball 770 and bias the ball 770 against the seat 769 to seal the opening 768. As best seen in FIG. 11B, the cage 780 includes a cylindrical or other housing 782 sized to surround the ball 770 and a plurality of supports, e.g., radial struts 784 extend from the housing 782 to contact the inner surface of the neck region 58 of the body 50 to prevent movement of the cage 780. The struts 784 may be secured to the neck region 58 by one or more of an interference fit, bonding with adhesive, sonic welding, fusing, and the like to prevent axial movement of the cage 780 away from the cap 760.

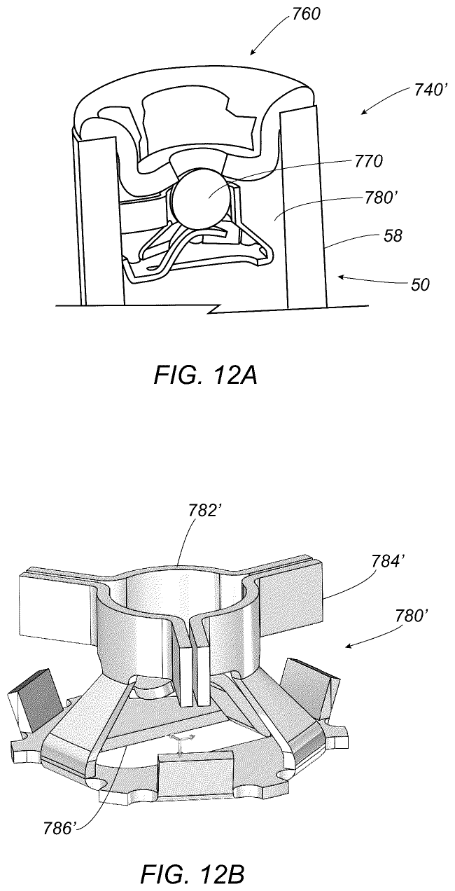

In addition, the cage 780 includes a biasing mechanism, e.g., a leaf spring 786 on the housing 783 opposite the cap 760, which may be biased to press the ball 770 into engagement with the seat 769 to seal the opening 768. However, if desired, during filling and/or during use of the canister 740, a pin, tool, or other element (not shown) may be inserted through the opening 768 to push the ball 770 away from the seat 769, e.g., to allow gas to be introduced into the canister 740 during filling and/or to allow pressurized gas to be released when an actuator directs a pin (not shown) through the opening 768. The spring 786 may accommodate the ball 770 being directed away from the seat 769 but resiliently bias the ball 770 to return back to press the ball 770 into the seat 769 when external forces are removed. FIGS. 12A and 12B show a variation of a cage 780′ that may be provided within the neck region 58 of a body to hold a ball 770 or other sealing member.

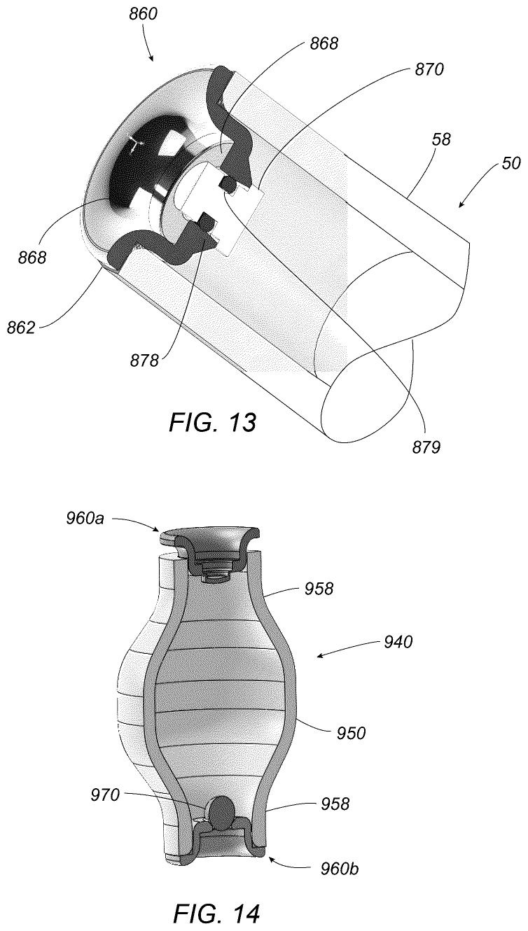

Turning to FIG. 13, another example of a sealing member, namely a cylindrical plug 870, is shown that may be sized to be received in an opening 868 through a cap 860 welded to a neck region 58 of a body 50, to provide a gas canister 840 generally similar to other canisters described herein. Unlike other canisters, the plug 870 is a cylindrical body including an O-ring 878 that is secured around the plug 870, e.g., within an annular groove 879. The plug 870 and O-ring 878 may be formed from materials having sufficient friction to secure the plug 870 within the opening 868 after filling the canister 840, but allowing the plug 870 to be displaced axially out of the opening 868 by an actuator pin (not shown). The materials of the plug 870 and O-ring 878 may be sufficiently durable such that heat from welding the cap 860 to the neck region 58 does not damage or impair the performance characteristics of the plug 870 during use of the canister 840.

Turning to FIG. 14, another example of a gas canister 940 is shown that may be constructed generally similar to any of the other canisters described elsewhere herein. In this example, the canister 940 includes a tubular body 950 with open opposite ends 958, and a cap 960a, 960b welded onto both ends. The caps 960a, 960b may be the same or different from one another and may include any of the caps described herein or in the references incorporated by reference herein. For example, as shown, the upper cap 960a includes a septum including a weakened region that may be opened by an opener pin (not shown), and the lower cap 960b includes a sealing member 970, e.g., configured to engage a seat and/or otherwise seal an opening in the cap 960b, similar to other caps herein.

During manufacturing or preparation of a tool or medical device, a canister, such as the canister 40 shown in FIGS. 1A-1C or any of the other canisters described herein, may be loaded into a tool or medical device to provide an energy source that may be controllably released to provide a desired discharge force to operate the medical device. As explained above, in some examples, the energy source may be pressurized CO2. For example, the IOL inserter 10 may be provided to the user with the canister 40 pre-loaded within the chamber 16 of the housing 12. Thus, in some instances, a medical device pre-loaded with the canister 40 may be a disposable, single-use device. In some examples, the cap 14 may be substantially permanently coupled to the housing 12, e.g., by bonding with adhesive, sonic welding, interference fit, one or more connectors, and the like (not shown) to prevent the cap 14 and canister 40 from being removed by the user.

Alternatively, the IOL inserter 10 may be a reusable device, e.g., in which the user may load one or more canisters 40 successively into the housing 12, as desired. For example, with the IOL inserter 10 shown in FIGS. 1A and 1B, the user may remove the cap 14 and load a new canister 40 into the chamber 16 of the main body portion 12 of the IOL inserter 10, e.g., such that the sealed opening 68 of the cap 60 is disposed adjacent the pin 34, as shown in FIG. 1A. The cap 14 may then be reconnected to the main body portion 12 to secure the canister 40 within the housing 12.

At any time, the actuator 30 may be activated to direct the carriage 32 proximally to the proximal position shown in FIG. 1B such that the pin 34 pushes the sealing member 70 away from the seat 69 or otherwise opens the opening 68, thereby delivering CO2 from the canister 40 into one or more passages of the IOL inserter 10. The released CO2 may be used to pressurize an incompressible liquid, e.g., silicone oil, within the housing 12, which may be used to deliver a lens from the lens compartment 22. The O-ring seal 36 may slide along the neck region 58 and prevent CO2 from leaking into the chamber 16 or elsewhere other than the intended passages within the IOL inserter 10. The actuator 30 may then be released, allowing the carriage 32 to return to the distal position shown in FIG. 1A.

After the procedure, the entire IOL inserter 10 may be disposed of or, if reusable, the canister 40 may be removed, the medical device may be cleaned and/or otherwise prepared for another procedure, at which time another canister may be loaded into the medical device.

Although the gas canisters herein have been described for use with an IOL inserter, it will be appreciated that the gas canisters may be used with other medical devices. For example, the gas canisters may be used within a syringe device, such as that disclosed in the patents identified elsewhere herein. For example, such a syringe device may include a needle or other cannula that may be used to deliver viscous or other fluids contained within the device into an eye, with the gas canister providing a discharge force that may be controlled by an actuator of the syringe device to controllably deliver the fluid into an eye. In other examples, the gas canisters may be used to power an auto-injector, e.g., with the released gas automatically advancing a needle and delivering one or more agents from the injector, e.g., as described in the patents incorporated by reference herein.

It is fully contemplated that the features, components, and/or steps described with respect to one or more embodiments, methods, or Figures may be combined with the features, components, and/or steps described with respect to other embodiments, methods, or Figures of the present disclosure.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A canister, comprising:
an elongate body comprising a barrel region defining a first diameter, an enclosed first end, and a neck region extending from the barrel region to an open second end defining an end wall, the elongate body defining a central axis extending between the first end and the second end;
a cap attached to the neck region to close the second end of the elongate body and enclose a cavity within the body, the cap comprising an end wall including an opening therethrough communicating with the cavity, and a seat surrounding the opening on an interior of the end wall; and
a sealing member within the neck region configured to engage the seat to seal the opening,
the cavity filled with pressurized fluid.

2. The canister of claim 1, wherein the cap comprises an outer flange attached over the end wall of the neck region.

3. The canister of claim 2, wherein the cap comprises a substantially flat outer surface.

4. The canister of claim 2, wherein the cap comprises an annular recess surrounding the opening.

5. The canister of claim 2, wherein the cap comprises an annular sleeve extending from the outer flange into the neck region such that the end wall is located within the neck region.

6. The canister of claim 5, wherein the sleeve has a diameter smaller than the neck region to provide a space between the sleeve and the neck region.

7. The canister of claim 1, wherein the sealing member comprises a spherical member and wherein the seat comprises a concave surface shaped to receive a portion of the spherical member to seal the opening.

8. The canister of claim 7, wherein the spherical member is loose within the neck region and internal pressure of the pressurized fluid within the cavity presses the spherical member against the seat to seal the opening.

9. The canister of claim 7, wherein the spherical member and the seat comprise ferromagnetic material that magnetically attracts the spherical member into the seat to seal the opening.

10-14. (canceled)

15. The canister of claim 7, further comprising pliable material on one or more surfaces of the seat to enhance sealing the opening when the spherical member is engaged with the seat.

16. The canister of claim 15, wherein the pliable material comprises an elastomeric coating on the one or more surfaces.

17. The canister of claim 1, wherein the sealing member comprises a poppet including a flat surface configured to engage the seat and a stem extending from the flat surface through the opening.

18. The canister of claim 17, wherein the seat comprises an annular shoulder surrounding the opening and wherein the poppet has a diameter larger than the annular shoulder such that the flat surface abuts the shoulder to engage the seat.

19. The canister of claim 18, wherein the poppet comprises a flat disk.

20. The canister of claim 17, further comprising a pliable material on the flat surface to enhance sealing the opening when the poppet is engaged with the seat.

21. The canister of claim 20, wherein the pliable material comprises an elastomeric coating on the flat surface.

22. The canister of claim 17, wherein the poppet is formed from pliable material to enhance sealing the opening when the poppet is engaged with the seat.

23. The canister of claim 1, wherein the sealing member comprises a poppet slidable axially within the neck region, the canister further comprising a spring element coupled to the poppet to bias the poppet against the seat.

24-30. (canceled)

31. A canister, comprising:
an elongate body comprising a barrel region defining a first diameter, an enclosed first end, and a neck region extending from the barrel region to an open second end defining an end wall, the elongate body defining a central axis extending between the first end and the second end;
a cap attached to the neck region to close the second end of the elongate body and enclose a cavity within the body, the cap comprising an end wall including an opening therethrough communicating with the cavity, and a seat surrounding the opening on an interior surface of the cap comprising a concave wall; and
a sealing member within the neck region comprising a spherical member configured to engage the concave wall of the seat to seal the opening,
the cavity filled with pressurized fluid.

32-71. (canceled)

71. A gas-actuated tool, comprising:
a housing comprising a functional portion and an actuator portion including a chamber;
a canister according to any one of claims 1-60 within the chamber;
a carriage carrying an opener pin movable within the housing from a first position where the pin is spaced from the opening of the canister and a second position where the pin at least partially enters the opening; and
an actuator on the actuator portion coupled to the carriage such that activation of the actuator causes the carriage to move from the first position to the second position such that the pin displaces the sealing member to open the opening, thereby releasing pressurized gas from the canister into one or more passages within the housing to provide energy to the functional portion.

72. (canceled)

73. A method for making a canister, comprising:
providing an elongate body comprising a barrel region, an enclosed first end, and a neck region extending from the barrel region to an open second end defining an end wall, the elongate body defining a central axis extending between the first end and the second end;
providing a cap comprising an outer flange and an opening therethrough surrounded by a seat and a sealing member configured to engage the seat to seal the opening;
stabilizing the sealing member relative to the cap;
introducing pressurized gas into an interior cavity of the elongate body;
placing the outer flange against the end wall; and
welding the flange to the end wall, thereby attaching the cap to the body to enclose the cavity with the pressurized gas therein.

74-99. (canceled)
